(19) United States
(12) Patent Application Publication
(10) Pub. No.: US 2009/0031052 A1
(43) Pub. Date: Jan. 29, 2009

(54) PRINT DEVICE DIAGNOSIS METHOD AND SYSTEM

(75) Inventors: Kirk V. Pothos, Webster, NY (US); Daniel James Stark, Webster, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Stamford, CT (US)

(21) Appl. No.: 11/829,437

(22) Filed: Jul. 27, 2007

(51) Int. Cl. G06F 11/30

(52) U.S. Cl. 710/15

(57) ABSTRACT

A system and method include a printing device having an embedded server that generates an electronic document. The content of the electronic document may he data representative of operational elements of the device. An application server may contain program instructions that request the electronic document from the printing device. A firewall may separate the printing device and the application server from an external hosted server. The application server may include program instructions to periodically poll the hosted server to determine whether the hosted server has issued an electronic document request. If the hosted server has issued an electronic document request, the application server may return content of the electronic document from the printing device to the hosted server.

### BACKGROUND

A call center is a centralized office used to receive and transmit multiple telephone or electronic requests or items of monitored data. Often a call center is operated by a business or company and is used to administer incoming product support or answer inquiries from a client. A call center is usually operated by call center agents who receive the calls or data and either directly respond to issues raised by the calls and data, or they may dispatch or assign service representatives to handle the issues at a client location.

Call center agents often work at a hosted server which is remote from a client site. Call center agents may want to determine if one or more printing devices within a client's firewall are functioning properly. If a printing device is not functioning properly, the call center agent may want to evaluate the printing device inside the firewall to determine how to correct the problem. However, it is usually very difficult for the call center agent to directly interact with the client's printing device, as the hosted server is often not permitted to retrieve information from inside a company's firewall.

Often when a printing device inside a firewall has a problem, a hosted server may only retrieve information from the printing device after obtaining permission from the company's firewall administrator. In order for the remote agent to access the printing device from the hosted server, the company's firewall administrator must reconfigure the company's system to permit the external hosted server to interact with the printing device. Alternatively, in order for a remote call center agent to access information about the printing device, the call center agent would have to dispatch a service agent to the client's site. In another alternative, the problem is often diagnosed remotely by a client at the client site describing the screen and messages to a call center agent.

### SUMMARY

In one embodiment, a print device maintenance monitoring system may include a printing device which has an embedded server that generates an electronic document. The content of the electronic document may include data representative of operational elements of the device. The system may include an application server which may contain program instructions that request the electronic document from the printing device and a firewall that separates the printing device and the application server from an external hosted server. The application server also may include program instructions to periodically poll the hosted server to determine whether the hosted server issued an electronic document request. If the hosted server has issued an electronic document request, the content of the electronic document may be returned from the printing device to the hosted server.

In one embodiment, data from the electronic document may be displayed in a display by the hosted server. After the application server returns content of the electronic document to the hosted server, the application server may determine if the hosted server requested a second electronic document. If the hosted server requested the second electronic document, the application server may return the information requested in the second request to the hosted server. In one embodiment, if the hosted server issued an electronic document request, a timed session may begin between the hosted server and the application server.

In an alternate embodiment, a method of determining a problem with a printing device may include communicating by an application server, through a firewall, with a hosted server and determining, by the application server, if the hosted server issued an electronic document request. If the hosted server issued an electronic document request, the application server may request the electronic document. The content of the electronic document may include data representative of operational elements of a printing device. The application server may receive the electronic document. The application server may send the content of the electronic document to the hosted server. The content may be used by the hosted server to determine a status of the printing device.

In one embodiment, communicating with a hosted server may include periodically polling the hosted server. In one embodiment, requesting the electronic document may include communicating, using program instructions, with the printing device. If the hosted server issued a second electronic document request by the application server, the application server may request the second electronic document. The application server may receive the second electronic document. The application server may send content of the second electronic document to the hosted server. The content of the electronic document may include configuration and parameter information about the printing device. The printing device may include a printer, a scanner, a copier, a fax, and/or a multifunction device. In one embodiment, if the hosted server issued an electronic document request, a timed session may be maintained. The timed session may end when the hosted server stops requesting a new electronic document. Communicating with a hosted server may include determining the optimal polling time for the application server during the timed session. In one embodiment, a time interval may be calculated and the application server may wait the time interval before polling the hosted server for a second electronic document request. If the hosted server did not issue an electronic document request, the hosted server may be periodically polled to determine if there is an electronic document request.

In an alternate embodiment, a resource maintenance monitoring system may include a resource having an embedded server that may generate an electronic document. The content of the electronic document may include data representative of operational elements of the resource. The system may include an application server that contains program instructions that request the electronic document from the resource and a firewall that separates the resource and the application server from an external hosted server. The application server may also include program instructions to periodically poll the hosted server to determine whether the hosted server has issued an electronic document request. If the hosted server has issued an electronic document request, content of the electronic document may be returned from the resource to the hosted server.

In one embodiment, the data from the electronic document may be displayed. After the application server returns content of the electronic document to the hosted server, the application server may determine if the hosted server requested a second electronic document. If the hosted server issued an electronic document request, a timed session may begin between the hosted server and the application server.

### BRIEF DESCRIPTION OF THE DRAWINGS

FIG. 1 depicts an exemplary system for diagnosing a condition of a resource behind a firewall in an embodiment.

FIG. 2 depicts a visual representation of an exemplary electronic document in an embodiment.

FIG. 3 depicts an exemplary method of communicating between a resource, application server and a hosted server in an embodiment.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean including but not limited to.” Unless defined otherwise, all technical and scientific terms used herein have the same meanings as commonly understood by one of ordinary skill in the art.

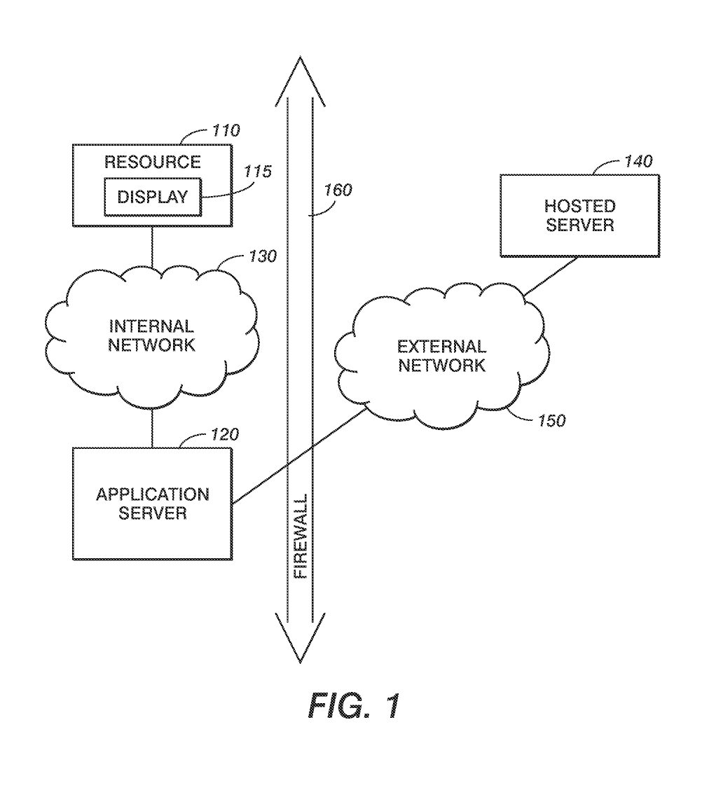

FIG. 1 depicts an exemplary system for diagnosing a condition of a resource behind a firewall in an embodiment. The system includes a resource 110. A resource is a device that generates an electronic document. A resource may include, but is not limited to, a printing device, a multifunction device, a router, a web application and other devices. A printing device is an electronic device that is capable of receiving commands and printing text and/or images on a substrate and/or scanning a document. Printing devices may include, but are not limited to, network printers, production printers, copiers, faxes, other devices using ink or toner, or scanners. As used herein, the words ink and toner are used interchangeably to refer to wet or dry material that forms an image or text on a substrate. Printing devices may also contain a combination of functions such as printing/scanning/faxing, in which case such devices may be considered to be multifunctional devices.

The resource 110 may have an embedded server that generates an electronic document. Electronic document content may include data that is representative of operational elements of the device. An electronic document may include, but is not limited to, a web page, a Hypertext Markup Language (HTML) document, an Extensible Markup Language (XML) document or other similar documents that contain a navigation element.

A resource may have a display 115. In one embodiment, the display 115 may display the data representative of one or more operational elements of the resource. By displaying the data representative of operational elements of the resource, a user viewing only the exterior of a resource may determine the resource's status. Data from the resource may include, but is not limited to age of the resource, status information, a time of the last status check, and a machine running time. For example, a user may determine if there are problems occurring inside a printing device by viewing the device's display.

The application server 120 may communicate with a resource 110 via an internal network 130 such as a local area network (LAN), wide area network (WAN), Internet or another communications network. An application server 120 is a type of software engine that provides applications or software programs to resources. The application server 120 may include program instructions that request an electronic document from a resource.

The system may also include an external hosted server 140. A hosted server stores and transmits information relating to one or more resources. In one embodiment, the hosted server may be located at a remote site. A firewall 160 may separate the external hosted server 140 from communicating with the resource 110 and the application server 120. A firewall 160 is an information technology security device which is configured to permit or deny data connections between external applications and internal applications. Internal applications are applications behind a firewall. For example, the application server 120 and the resource 110 are internal applications. Data retrieved from external applications must meet the firewall's security criteria in order to be received by the internal applications.

The hosted server may collect information about one or more resources through the application server. In one embodiment, a hosted server 140 is located at a data center. The application server 120 may communicate with the hosted server 140 through the firewall via an external network 150.

The application server and the hosted server may communicate because the application server polled the hosted server. In prior systems, a hosted server would not be able to request a document through a firewall. However, the hosted server may communicate with the application server because the application server initiated communication through polling. Therefore, the hosted server may respond to the application server's poll and may communicate through the firewall.

The application server 120 may include program instructions to periodically poll the hosted server 140 to determine whether the hosted server has posted an electronic document request. For example, the application server may poll the hosted server hourly, daily, every five minutes, or every three hours. If the hosted server 140 has issued an electronic document request, a timed session (i.e., communication session lasting for a set period of time) may begin and the application server 120 may send the content of the electronic document from the resource 110 to the hosted server 140, where the hosted server optionally may direct the display of the document. During the timed session, the application server may poll the hosted server at a higher rate than during other times. For example, the application server may periodically poll the hosted server every ten seconds. However, during the timed session, the application server may poll the hosted server on a periodic basis, such as every two seconds.

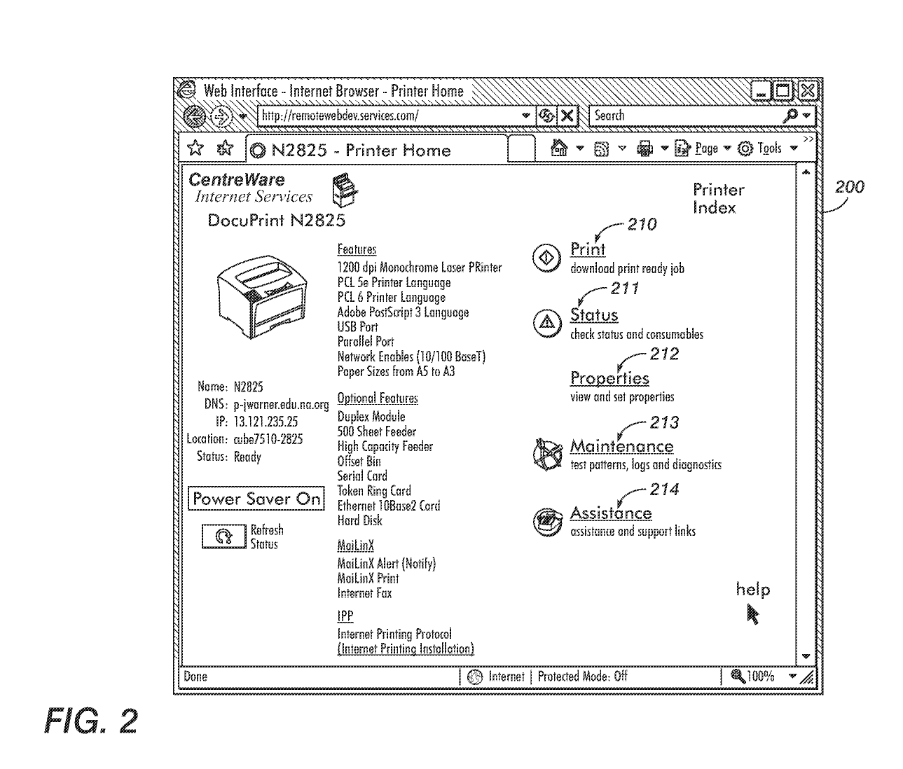

FIG. 2 depicts a visual representation of an exemplary electronic document in an embodiment. According to FIG. 2, an electronic document 200 for a resource includes data representative of the operational elements of the resource. The electronic document may be generated by a server embedded inside the resource. The electronic document content may include internal workings of the resource. In one embodiment, the content from the electronic document may provide information regarding the status and/or functionality of a resource.

Referring to FIG. 2, the electronic document 200 may include operations elements such as print 210, status 211, properties 212, maintenance 213, and assistance information 214. In one embodiment, the print information 210 may provide the hosted server with information about downloaded print jobs. Additionally, information such as printing time, pages printed, how many people utilize a resource, monochrome ink use, and color ink use may be provided. The status information 211 of the electronic document may provide the hosted server with information necessary to determine if the resource is functioning properly. Additionally, information about maintenance 213 such as the patterns, logs and diagnostics may be provided in an electronic document. Additional and/or alternative information about a resource may be provided.

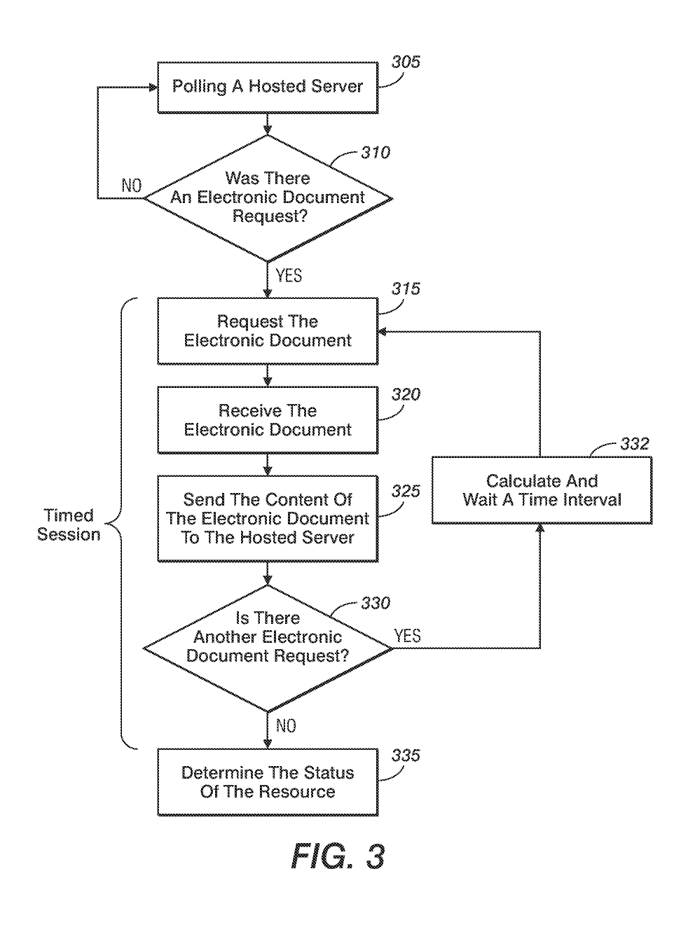

FIG. 3 depicts an exemplary method of communicating between a resource, an application server and a hosted server in an embodiment. An application server may include program instructions to poll the hosted server 305. In one embodiment, the application server may communicate with the hosted server after a predetermined time, a random time, or a calculated time. In one embodiment, the application server may periodically poll the hosted server.

The application server may poll the hosted server because the firewall prohibits the hosted server from initiating communication with the resource or the application server located behind the firewall. However, the hosted server may request an electronic document by posting an electronic document request. In one embodiment, the request may be for an electronic document from a single resource. Alternatively, the request may be for electronic documents for two or more resources. In one embodiment, the hosted server may issue a request for an electronic document for a particular resource. Alternatively, the request may be for an electronic document from any resource.

When the application server polls the hosted server, the application server may determine whether the hosted server issued an electronic document request 310. If there is no request posted by the hosted server, then the application server may wait before polling the hosted server again 305. In some embodiment, the application server may wait a predetermined, variable, or random time before polling the hosted server.

If a request was posted by the hosted server, the application server may obtain the request in order to request the electronic document from the resource 315. In one embodiment, a timed session between the hosted server and the application server may begin when the request is received by the application server. In one embodiment, the application server may request the electronic document from the resource using program instructions.

The application server may receive the electronic document from the resource 320 during the timed session. After the electronic document is received, the application server may send the content of the electronic document to the hosted server 325. The application server may then poll the hosted server to determine if there is another electronic document request 330. If there is another request posted by the hosted server, the application server may receive the request in order to obtain the electronic document from the resource 315. The application server may obtain the electronic document from the resource 320. If there is not another electronic document request from the hosted server, then the timed session may end.

In one embodiment, during the timed session there may be a document session. A document session is a self-adjusted timed session. If an electronic document request is issued by the hosted server, the application server may perform that request and respond with the document. A time interval may be calculated and the application server may wait the time interval before the application server polls the hosted server to determine if there is another electronic document request 332. In one embodiment, the time interval may be a predetermined period of time. In one embodiment, the time interval may be adjusted during the timed session. For example, the time interval may begin with a waiting time of 750 milliseconds. In one embodiment, the time interval may correspond to the time needed for the hosted server to process the previous document response and send the response to the application server as well as the time needed for the application server to issue another request to the resource as a result of processing that document.

The application server may then poll the hosted server again to determine if there is another electronic document request waiting. The time interval may be optimized based on the speed of the electronic document requests. If there is an electronic document request waiting at the hosted server, then the time interval may be reduced by a percentage. In one embodiment, the percentage may be a predetermined time. If there is not an electronic document request waiting at the hosted server, then the time interval may be increased by a percentage. In one embodiment, when two sequential document session polls fail to collect another electronic document request from the hosted server, the document session may end and the periodic polling for requests, as discussed above, may resume.

For example, inside a company's firewall a printing device may not be functioning properly. An application server may interact with the printing device behind the firewall. The application server may periodically poll a hosted server located at a remote call center 305. The hosted server may belong to the company that manufactured the printing device. After the hosted server is polled, the application server may determine if there was an electronic document request posted by the hosted server 315. If no electronic document request was posted 310, then the application may wait and poll the hosted server again at a later time 305. However, if there was an electronic document request, the application server may receive the request for the electronic document. The application server may request the electronic document from the printing device 315. The printing device may send its electronic document to the application server so that the application server receives the electronic document 320. After the electronic document is received by the application server, the application server may send the content of the electronic document to the hosted server 325.

In one embodiment, a hosted server may issue a first electronic document request. The application server may respond with the content of the electronic document from the resource 325. The hosted server may receive the content of the electronic document and then may generate a second electronic document request 330. After receiving the second electronic document request, the application server may respond to the second electronic document request 315, 325. This process of communication may continue until no electronic document requests are posted at the host server 330.

Upon receiving the content of one or more electronic documents, a user at the hosted server may determine the status of the resource 335. In one embodiment, the user at the hosted server may determine if there are any problems with the resource. The electronic document content may allow the user at the hosted server to remotely diagnose problems with the resource.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A print device maintenance monitoring system comprising:
a printing device having an embedded server that generates an electronic document, wherein content of the electronic document comprises data representative of operational elements of the device;
an application server containing program instructions that request the electronic document from the printing device; and
a firewall that separates the printing device and the application server from an external hosted server,
wherein the application server also includes program instructions to periodically poll the hosted server to determine whether the hosted server issued an electronic document request, and, if the hosted server has issued an electronic document request, return content of the electronic document from the printing device to the hosted server.

2. The system of claim 1 wherein the data from the electronic document is displayed by the hosted server.

3. The system of claim 1 wherein after the application server returns content of the electronic document to the hosted server, the application server determines if the hosted server issued a second electronic document request.

4. The system of claim 3 wherein if the hosted server issued the second electronic document request, the application server returns content of a second electronic document to the hosted server.

5. The system of claim 1 wherein if the hosted server issued an electronic document request, a timed session begins between the hosted server and the application server.

6. A method of determining a problem with a printing device comprising:
communicating by an application server, through a firewall, with a hosted server; and
determining, by the application server, if the hosted server issued an electronic document request;
if so:
requesting, by the application server, the electronic document, wherein content of the electronic document comprises data representative of operational elements of a printing device,
receiving, by the application server, the electronic document, and
sending, by the application server, content of the electronic document to the hosted server; and
using, by the hosted server, the content to determine a status of the printing device.

7. The method of claim 6 wherein communicating with a hosted server comprises periodically polling the hosted server.

8. The method of claim 6 wherein requesting the electronic document comprises communicating, using program instructions, with the printing device.

9. The method of claim 6 further comprising:
if the hosted server issued a second electronic document request to the application server:
requesting, by the application server, a second electronic document;
receiving, by the application server, the second electronic document, and
sending, by the application server, content of the second electronic document to the hosted server.

10. The method of claim 6 wherein the content of the electronic document further comprises configuration and parameter information about the printing device.

11. The method of claim 6 wherein the printing device is at least one of the following:
a printer, a scanner, a copier, a fax, and a multifunction device.

12. The method of claim 6 wherein if the hosted server issued an electronic document request, the method further comprises maintaining a timed session.

13. The method of claim 12 further comprising:
ending the timed session when no new electronic document request is issued by the hosted server.

14. The method of claim 6 further comprising:
calculating a time interval;
waiting the time interval before polling, by the application server, the hosted server for a second electronic document request.

15. The method of claim 6 wherein communicating with a hosted server comprises determining an optimal polling time for the application server during a timed session.

16. The method of claim 6 wherein determining if the hosted server issued an electronic document request comprises periodically polling the hosted server.

17. A resource maintenance monitoring system comprising:
a resource having an embedded server that generates an electronic document, wherein content of the electronic document comprises data representative of operational elements of the resource;
an application server containing program instructions that request the electronic document from the resource; and
a firewall that separates the resource and the application server from an external hosted server,
wherein the application server also includes program instructions to periodically poll the hosted server to determine whether the hosted server has issued an electronic document request, and, if the hosted server has issued an electronic document request, return content of the electronic document from the resource to the hosted server.

18. The system of claim 17 wherein the data from the electronic document is displayed.

19. The system of claim 17 wherein after the application server returns content of the electronic document to the hosted server, the application server determines if the hosted server requested a second electronic document.

20. The system of claim 17 wherein if the hosted server issued an electronic document request, a timed session begins between the hosted server and the application server.
